(19) United States
(12) Patent Application Publication
(10) Pub. No.: US 2019/0180350 A1
(43) Pub. Date: Jun. 13, 2019

(54) METHOD AND SYSTEM FOR A MASS PURCHASING PLATFORM

(71) Applicant: Mastercard International Incorporated, Purchase, NY (US)

(72) Inventors: Antonio MARRA, Fishkill, NY (US); Prashant SHARMA, Madison, NJ (US); Manash BHATTACHARJEE, Jersey City, NJ (US)

(73) Assignee: Mastercard International Incorporated, Purchase, NY (US)

(21) Appl. No.: 15/834,620

(22) Filed: Dec. 7, 2017

(51) Int. Cl. G06Q 30/06

(52) U.S. Cl. CPC G06Q 30/0637

(57) ABSTRACT

A method for facilitating a mass market purchase includes: transmitting an offer notification to a plurality of computing devices, the notification including a minimum acceptance number, product information, and transaction amount; receiving an offer acceptance from one of the computing devices, the acceptance including payment credentials associated with a transaction account; initiating placement of an authorization hold on the transaction account for the transaction amount; repeating the receiving and initiating steps a number of times for offer acceptances received by additional computing devices; and if the number of times is at least the minimum acceptance number, initiating a payment transaction for each of offer acceptance for payment of the transaction amount from the respective transaction account based on the corresponding authorization hold, or if the number of times is less than the minimum acceptance number, initiating clearing of the authorization hold corresponding to the respective offer acceptance.

### FIELD

The present disclosure relates to a platform enabling a mass market purchase, specifically a platform that enables merchants to reach out to consumers interested in a mass market purchase to facilitate such a purchase by use of authorization holds and subsequent transactions if a sufficient number of consumers commit to the purchase.

### BACKGROUND

Consumers often visit merchants, both at a physical storefront and via web pages and other remote, electronic methods, interested in a type of product without being certain as to their intent to make a purchase. The consumer may browse the merchant's wares to see what they have in stock, and, in many cases, keep a keen eye on the price of such wares. If the consumer is not satisfied with the selection of products or, more often than not, the price at which such products are offered, the consumer may leave. In these instances, the merchant may be unaware of the reason for the consumer's departure, if they were aware of the consumer's visit at all. It can thus be very difficult for a merchant to identify when they lose out on these types of sales, which may happen with an alarming regularity.

In many cases, consumers may visit a merchant and decline to purchase a product because the price is too high. Generally, a merchant prices its product at a value that they feel will be most profitable for them in the long run; if some consumers are not willing to spend the amount it is often outweighed by the number of consumers willing to pay the set price. However, it can be difficult, or even impossible, for the merchant to identify the actual number of consumers that decline to purchase the product due to price, or more importantly identify a price at which such consumers would be willing to make the purchase. Merchants may be willing to allow consumers to purchase a product at a lower price than originally set, provided they had assurance that they would sell a sufficient amount to make the price adjustment worthwhile. At times, consumers may talk to each other (e.g., neighbors, coworkers or businesses) to arrange for a joint purchase to reach for a bulk discount, but these are haphazard and communication intensive.

These problems present real business and technological problems for the merchant, which can be solved by technological solutions in accordance with some exemplary embodiments of the system and method disclosed below. Currently there appears to be no systems that are capable of making such a prospective deal between merchants and consumers. For instance, Groupon® currently sells vouchers for meals and other services, but requires that consumers pay in advance even if a voucher is not honored, requiring the consumer to then seek a refund, which may discourage some consumers. As a result, merchants continue to lose out on potential business, and consumers are unable to leverage their position to get a better deal on such products because of the inefficiency of how this might be communicated, tracked and the sale arranged and the products distributed. Thus, there is a need for a technological system to provide a mass market purchase platform that can facilitate such types of sales.

### SUMMARY

The present disclosure provides a description of systems and methods for mass market purchases. A merchant indicates to the platform a discounted price for a product that they are willing to accept provided a minimum number of consumers is willing to purchase the product at the discounted price. The platform reaches out with alerts or postings to consumers to find out which are willing to commit to purchasing the product at the discounted price, placing payment card authorization holds on their accounts for the discounted price. If the minimum number of consumers is met during a predetermined period of time during which the deal is open, the mass market deal may be considered accepted and fulfilled. The platform may proceed with payment transactions for each of the consumers via the previously set authorization holds, resulting in the minimum number of purchases being made at the discounted price. The result is that the merchant has a sufficient number of sales that made offering the discount worthwhile, while the consumers get to take advantage of the discount. The platform thus facilitates purchases that would not have happened otherwise, satisfying both consumers and merchants alike.

A method for facilitating a mass market purchase includes: electronically transmitting, by a transmitting device of a processing server, an offer notification to a plurality of computing devices, wherein the offer notification includes at least a minimum acceptance number, product information, and a transaction amount; receiving, by a receiving device of the processing server, an offer acceptance from one of the plurality of computing devices, wherein the offer acceptance includes at least payment credentials associated with a transaction account; initiating, by a transaction processing module of the processing server, placement of an authorization hold on the transaction account associated with the payment credentials included in the received offer acceptance, wherein the authorization hold is for at least the transaction amount; repeating the receiving and initiating steps a number of times for offer acceptances received by additional computing devices of the plurality of computing devices; and if the number of times is at least the minimum acceptance number, initiating, by the transaction processing module of the processing server, a payment transaction for each of the received offer acceptances for payment of the transaction amount from the respective transaction account using the included payment credentials based on the corresponding authorization hold, or if the number of times is less than the minimum acceptance number, initiating, by the transaction processing module of the processing server, clearing of the authorization hold corresponding to the respective offer acceptance for each of the received offer acceptances.

A system for facilitating a mass market purchase includes: a transmitting device of a processing server configured to electronically transmit an offer notification to a plurality of computing devices, wherein the offer notification includes at least a minimum acceptance number, product information, and a transaction amount; a receiving device of the processing server configured to receive an offer acceptance from one of the plurality of computing devices, wherein the offer acceptance includes at least payment credentials associated with a transaction account; a transaction processing module of the processing server configured to initiate placement of an authorization hold on the transaction account associated with the payment credentials included in the received offer acceptance, wherein the authorization hold is for at least the transaction amount, wherein receiving an offer acceptance and initiating placement of an authorization hold are repeated a number of times for offer acceptances received by additional computing devices of the plurality of computing device, and if the number of times is at least the minimum acceptance number the transaction processing module of the processing server is further configured to initiate a payment transaction for each of the received offer acceptances for payment of the transaction amount from the respective transaction account using the included payment credentials based on the corresponding authorization hold, or if the number of times is less than the minimum acceptance number the transaction processing module of the processing server is further configured to initiate clearing of the authorization hold corresponding to the respective offer acceptance for each of the received offer acceptances.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for a mass market purchase platform in accordance with exemplary embodiments.

FIG. 2 is a block diagram illustrating the processing server of the system of FIG. 1 for the facilitating of mass market purchases in accordance with exemplary embodiments.

FIG. 3 is a flow diagram illustrating a process for the providing of a platform used to develop mass market purchases using the processing server of FIG. 2 in accordance with exemplary embodiments.

FIG. 4 is a flow diagram illustrating a process for the facilitation of a mass market purchase using the processing server of FIG. 2 in accordance with exemplary embodiments.

FIG. 5 is a flow chart illustrating an exemplary method for facilitating a mass market purchase in accordance with exemplary embodiments.

FIG. 6 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes for thousands, millions, and even billions of transactions during a given period. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Payment Rails—Infrastructure associated with a payment network used in the processing of payment transactions and the communication of transaction messages and other similar data between the payment network and other entities interconnected with the payment network that handles thousands, millions, and even billions of transactions during a given period. The payment rails may be comprised of the hardware used to establish the payment network and the interconnections between the payment network and other associated entities, such as financial institutions, gateway processors, etc. In some instances, payment rails may also be affected by software, such as via special programming of the communication hardware and devices that comprise the payment rails. For example, the payment rails may include specifically configured computing devices that are specially configured for the routing of transaction messages, which may be specially formatted data messages that are electronically transmitted via the payment rails, as discussed in more detail below.

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have or require any special knowledge in offered products. In some embodiments, an entity involved in a single transaction may be considered a merchant. In some instances, as used herein, the term “merchant” may refer to an apparatus or device of a merchant entity.

Issuer—An entity that establishes (e.g., opens) a letter or line of credit in favor of a beneficiary, and honors drafts drawn by the beneficiary against the amount specified in the letter or line of credit. In many instances, the issuer may be a bank or other financial institution authorized to open lines of credit. In some instances, any entity that may extend a line of credit to a beneficiary may be considered an issuer. The line of credit opened by the issuer may be represented in the form of a payment account, and may be drawn on by the beneficiary via the use of a payment card. An issuer may also offer additional types of payment accounts to consumers as will be apparent to persons having skill in the relevant art, such as debit accounts, prepaid accounts, electronic wallet accounts, savings accounts, checking accounts, etc., and may provide consumers with physical or non-physical means for accessing and/or utilizing such an account, such as debit cards, prepaid cards, automated teller machine cards, electronic wallets, checks, etc.

Acquirer—An entity that may process payment card transactions on behalf of a merchant. The acquirer may be a bank or other financial institution authorized to process payment card transactions on a merchant's behalf. In many instances, the acquirer may open a line of credit with the merchant acting as a beneficiary. The acquirer may exchange funds with an issuer in instances where a consumer, which may be a beneficiary to a line of credit offered by the issuer, transacts via a payment card with a merchant that is represented by the acquirer.

Payment Transaction—A transaction between two entities in which money or other financial benefit is exchanged from one entity to the other. The payment transaction may be a transfer of funds, for the purchase of goods or services, for the repayment of debt, or for any other exchange of financial benefit as will be apparent to persons having skill in the relevant art. In some instances, payment transaction may refer to transactions funded via a payment card and/or payment account, such as credit card transactions. Such payment transactions may be processed via an issuer, payment network, and acquirer. The process for processing such a payment transaction may include at least one of authorization, batching, clearing, settlement, and funding. Authorization may include the furnishing of payment details by the consumer to a merchant, the submitting of transaction details (e.g., including the payment details) from the merchant to their acquirer, and the verification of payment details with the issuer of the consumer's payment account used to fund the transaction. Batching may refer to the storing of an authorized transaction in a batch with other authorized transactions for distribution to an acquirer. Clearing may include the sending of batched transactions from the acquirer to a payment network for processing. Settlement may include the debiting of the issuer by the payment network for transactions involving beneficiaries of the issuer. In some instances, the issuer may pay the acquirer via the payment network. In other instances, the issuer may pay the acquirer directly. Funding may include payment to the merchant from the acquirer for the payment transactions that have been cleared and settled. It will be apparent to persons having skill in the relevant art that the order and/or categorization of the steps discussed above performed as part of payment transaction processing.

### System for Mass Market Purchases

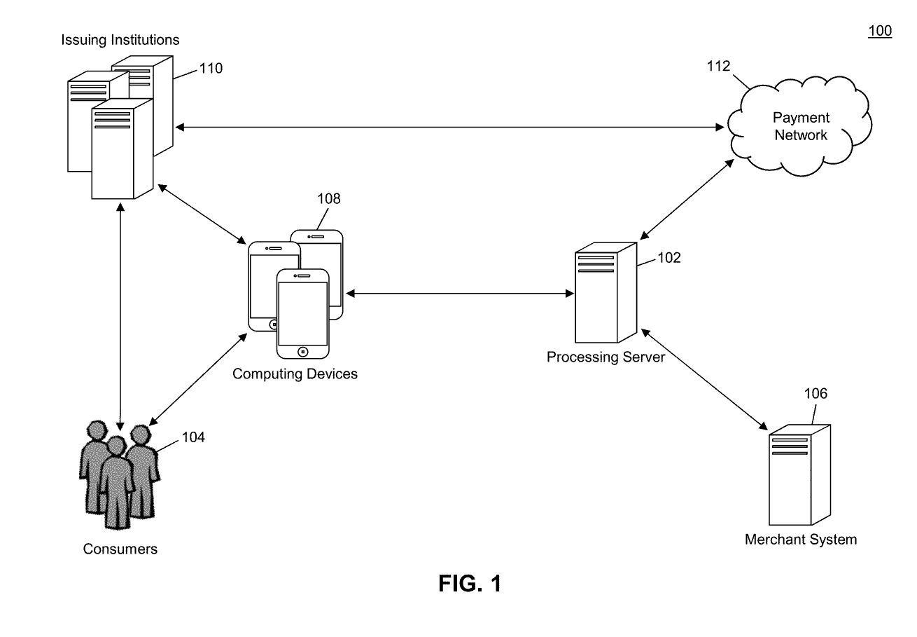

FIG. 1 illustrates a system 100 for the facilitation of mass market purchases between consumers and merchants via a mass market purchase platform designed to match consumers desiring a discounted price for a product to merchants willing to accept such a price at a specified volume that uses authorization holds to ensure consumer participation.

The system 100 may include a processing server 102. The processing server 102, discussed in more detail below, may be configured to provide a platform that facilitates mass market purchases between a plurality of consumers 104 and a merchant system 106. The mass market purchase may be a purchase of one or more products by a minimum number of consumers 104 at a discounted price, such that participation by the minimum number of consumers 104 is sufficient enough for the merchant associated with the merchant system 106 to be satisfied with selling the product(s) at the discounted price.

In the system 100, mass market purchases may be set up at the behest of either the consumers 104 or the merchant system 106. In latter instances, the merchant system 106 may electronically transmit a proposed mass market purchase to the processing server 102 using a suitable communication network and method, such as via an application programming interface operated by the processing server 102. The proposed mass market purchase may include information identifying the product or products that are available in the purchase, the discounted price that the merchant is willing to accept, and the minimum number of consumers 104 that may be required to commit to the purchase for the purchase to be carried out.

In other instances, consumers 104 may communicate their desire to purchase one or more products at a discounted price to the processing server 102 via computing devices 108 associated therewith. The computing devices 108 may be any types of computing devices suitable for performing the functions discussed herein, such as desktop computers, laptop computers, notebook computers, tablet computers, cellular phones, smart phones, smart watches, smart televisions, wearable computing devices, implantable computing devices, etc. Communications between the computing devices 108 and the processing server 102 may utilize any suitable communication network and method, such as an application program executed by the computing device 108 and associated with the processing server 102, application program interfaces operated by the processing server 102, web pages, etc. The consumers 104 may submit the desires to the processing server 102, which may identify the product(s) and indicate that they are willing to purchase the product(s) at a discounted price. In some cases, the consumers 104 may provide the actual price or a range of prices that they are willing to accept. In such instances, the processing server 102 may communicate such data to a merchant system 106, providing the merchant with the number of consumers 104 that have indicated a desire to purchase product(s) at a discounted price and, if available, the pricing information. The merchant system 106 may then design a mass market purchase offer around the consumers' desires.

In some embodiments, the processing server 102 may be configured to provide such information to a plurality of different merchant systems 106. In such embodiments, merchant systems 106 may bid or otherwise compete for the mass market purchase. For instance, merchant systems 106 may submit bids to the processing server 102 with their desired criteria (e.g., discounted price and minimum number of consumers), where the processing server 102 may then select a bid accordingly. For example, the processing server 102 may select the bid that provides the greatest discount, the bid that requires the smallest number of participant consumers 104, or a combination thereof. In some cases, the mass market purchase may be auctioned out to merchants, with the merchants offering an amount of funds or a portion of the profits from the mass market purchase to win the bid.

Once an offer for mass market purchase has been submitted to the processing server 102 by a merchant system 106, the offer may be communicated to consumers 104 by the processing server 102. The processing server 102 may electronically transmit offer notifications to a plurality of computing devices 108 that are associated with consumers 104 that may be willing to participate in the mass market purchase. Such consumers 104 may be identified based on their communicated desire, use of an application program associated with the processing server 102, visitation to a web page that includes the offer notification, or other suitable method. The offer notification may include at least information identifying the product(s) that are being offered, the discounted price, and the minimum number of consumers 104 that must commit to the mass market purchase for the purchase to be honored. In some cases, the offer notification may indicate the number of consumers 104 that have already accepted the offer if such data is available. In some embodiments, such a number may be updated in real-time as a consumer 104 accesses the offer notification via their computing device 108.

If a consumer 104 is interested in the mass market purchase, they may use their computing device 108 to commit to the purchase. As part of the commitment, the consumer 104 may, using their computing device 108, submit payment credentials to the processing server 102 that are associated with a transaction account that is to be used to fund a payment transaction for their participation in the mass market purchase. In the system 100, an issuing institution 110 may issue a transaction account to a consumer 104 that can be used to fund payment transactions. Issuing institutions 110 may be any type of institution, such as a financial institution (e.g., an issuing bank), that is configured to issue transaction accounts to consumers 104 that are able to fund payment transactions. As part of the issuing of a transaction account, the issuing institution 110 may provide payment credentials to the consumer 104, such as in the form of a physical payment card, a virtual payment card (e.g., to a computing device 108), or other suitable form. The consumer 104 may provide these payment credentials to the processing server 102 via their computing device 108 if interested in the mass market purchase. Payment credentials may include any necessary data for ensuring that a payment transaction can be processed that is funded by the corresponding transaction account, such as a primary account number, name, expiration date, security code, etc.

When the processing server 102 receives an offer acceptance from a consumer 104, an authorization hold may be placed on the transaction account that corresponds to the supplied payment credentials for the transaction amount that satisfies the proposed mass market purchase (e.g., the discounted price, plus any taxes and fees, if applicable). The processing server 102 may generate a transaction message that is submitted to a payment network 112 via payment rails associated therewith, where the transaction message is configured to place an authorization hold on the transaction account for the transaction amount. In some embodiments, the transaction message may be compliant with one or more standards governing the exchange of financial transaction messages, such as the International Organization of Standardization's ISO 8583 or ISO 20022 standards. In such embodiments, the transaction message may include a message type indicator indicating that an authorization hold is to be placed. The payment network 112 may process the transaction message using traditional methods and systems, which may include communicating the transaction message and/or data included therein to the issuing institution 110 that issued the transaction account indicated by the payment credentials included in the transaction message (e.g., identified via an issuer identification number). The issuing institution 110 may then place an authorization hold on the transaction account for the stated transaction amount. The payment network 112 may inform the processing server 102 of the successful placing of the hold on the transaction account. In some cases, the processing server 102 may provide a notification to the computing device 108 upon successful placement of the authorization hold.

The processing server 102 may continue to receive offer acceptances from the computing devices 108 while the mass market purchase remains available for acceptance. In some embodiments, the offer may only remain open for a predetermined period of time, which may be set by the processing server 102 or by the merchant system 106 in the submission of the mass market purchase. For example, the merchant may require that the minimum number of consumers 104 accepts the offer in a two week period. In other embodiments, the mass market purchase may remain available until the minimum number of consumers 104 has accepted the offer.

In cases where the mass market purchase may expire, once criteria has been met that triggers expiration of the mass market purchase (e.g., the predetermined period of time has passed), the processing server 102 may clear the authorization holds placed on the transaction accounts for the consumers 104 that accepted the offer. The processing server 102 may submit a transaction message to the payment network 112 for each of the offer acceptances that is configured to clear the corresponding authorization hold once processed by the payment network 112 using traditional methods and systems. The processing server 102 may also submit a notification to the computing device 108 associated with each offer acceptance indicating that the mass market purchase offer has expired and their authorization hold cleared. In some instances, the notification may indicate a reason for the expiration, and may also indicate the number of consumers 104 that had accepted the offer. For example, the consumers 104 that accepted the offer may learn that they were very close to fulfilling the minimum number set by the merchant, and may indicate a desire to accept a mass market purchase at a slightly higher price that would satisfy the merchant or encourage the remaining number of consumers 104 to participate, such that the merchant system 106 may submit a new mass market purchase request to the processing server 102.

In cases where the minimum number of consumers 104 have accepted the offer, the mass market purchase may be carried out. The processing server 102 may generate and submit a transaction message to the payment network 112 via payment rails associated therewith for each of the consumers 104 that accepted the offer, where the transaction message refers to the previous, corresponding authorization hold and indicates that the payment transaction should be processed. The payment network 112 may then process the payment transaction using traditional methods and systems, which may result in payment of the amount of the authorization hold to a transaction account associated with the merchant system 106. The mass market purchase may be thus carried out, where the minimum number of consumers 104 purchases the product(s) at the discounted price, where each consumer 104 is committed to the purchase prior to it being made, and where the merchant is guaranteed of consumer participation provided the minimum number of consumers 104 is met.

In some embodiments, a merchant may set up tiers of consumer participation and corresponding discounted price amounts. For instance, the merchant system 106 may submit a mass market purchase offer to the processing server 102 that includes the minimum number of consumers and a transaction amount, but also includes a secondary number of consumers that is greater than the minimum number of consumers along with a corresponding secondary transaction amount that is less than the initial transaction amount. In such a case, if the number of consumers 104 that accepts the offer prior to the deadline (e.g., predetermined period set by the merchant system 106) reaches the secondary number, the consumers 104 may get the product(s) at the greater discounted price. In some such cases, the mass market purchase may be designed such that the greater discount is only provided to the first minimum number of consumers 104 that accept the offer or those that accept the offer prior to an earlier predetermined period has expired, such as to encourage early acceptors to help the offer gain traction. In some instances, secondary prices may have a secondary period of time associated therewith, where the secondary number of consumers 104 or the minimum number of consumers 104 must accept the offer prior to expiration of the secondary period of time, shorter than the overall period of time, for the secondary price to be used. While the use of two minimum numbers of consumers 104, two transaction amounts, and two periods of time are described, there may be no limit to the number of each criteria included in a mass market purchase offer. For instance, there may be ten, twenty, one hundred, etc. levels of participation that may result in different discounts.

The methods and systems discussed herein provide for a platform operated by the processing server 102 that can facilitate mass market purchases between consumers 104 and merchant systems 106. The use of authorization holds ensures a commitment to a potential mass market purchase by a consumer 104 that provides assurance to a merchant system 106 that the required number of sales will occur if a sufficient number of consumers 104 commits. At the same time, the use of an authorization holds provides a consumer 104 with an opportunity to cancel their participation, if necessary, and also ensures that their money will not be lost if the mass market purchase does not occur (e.g., they will only pay for the product if they can get it at the agreed-upon price). In cases where multiple tiers of an offer may be used, consumers 104 may receive even greater discounts based on their commitment to the mass market purchase. Thus, the processing server 102 provides benefits to both consumers 104 and merchants alike, providing a service to both that does not currently exist on the market.

### Processing Server

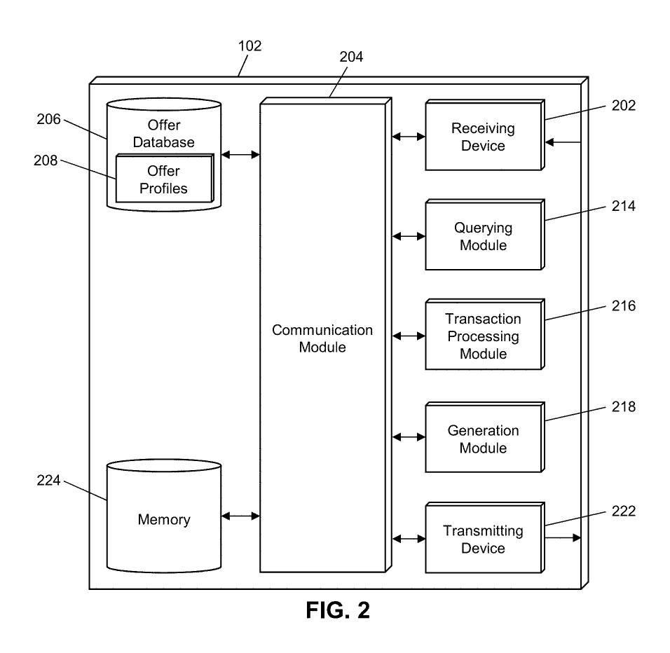

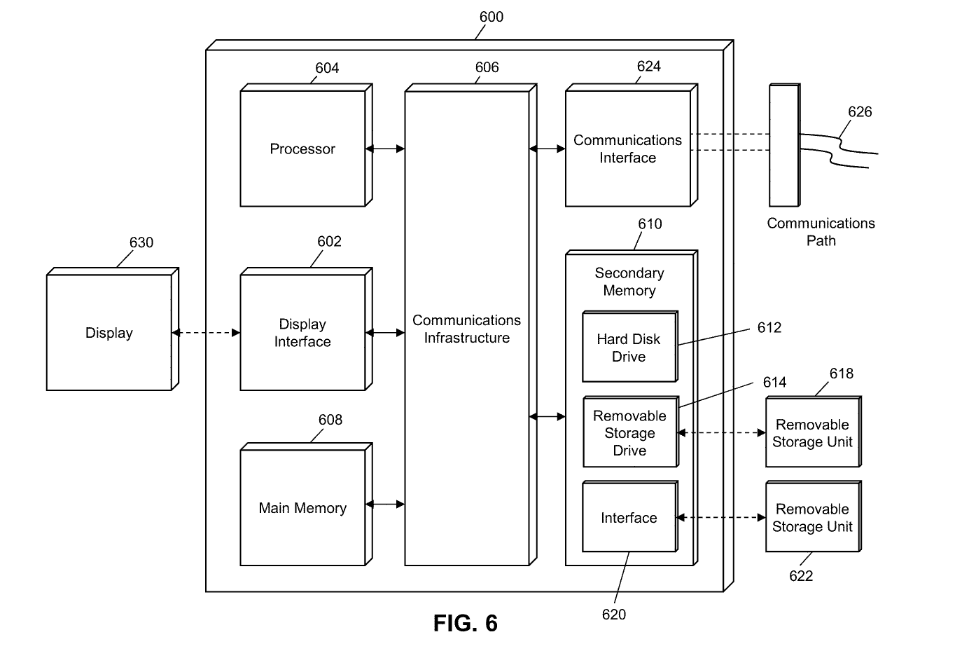

FIG. 2 illustrates an embodiment of a processing server 102 in the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 600 illustrated in FIG. 6 and discussed in more detail below may be a suitable configuration of the processing server 102.

The processing server 102 may include a receiving device 202. The receiving device 202 may be configured to receive data over one or more networks via one or more network protocols. In some instances, the receiving device 202 may be configured to receive data from merchant systems 106, computing devices 108, payment networks 112, and other systems and entities via one or more communication methods, such as radio frequency, local area networks, wireless area networks, cellular communication networks, Bluetooth, the Internet, etc. In some embodiments, the receiving device 202 may be comprised of multiple devices, such as different receiving devices for receiving data over different networks, such as a first receiving device for receiving data over a local area network and a second receiving device for receiving data via the Internet. The receiving device 202 may receive electronically transmitted data signals, where data may be superimposed or otherwise encoded on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals electronically transmitted by merchant systems 106 that are superimposed or otherwise encoded with mass market purchase requests. Such requests may include product information, at least one discounted transaction amount, and at least one minimum number of consumers. In some cases, a request may also include at least one of: one or more predetermined periods of time, additional numbers of consumers, additional discounts, or combinations thereof. The receiving device 202 may also be configured to receive data signals electronically transmitted by computing devices 108, which may be superimposed or otherwise encoded with offer acceptances, which may include at least payment credentials associated with a transaction account. In cases where the processing server 102 may have multiple mass market purchase offers being offered at a time, an offer acceptance may also include a unique identification value that is associated with a mass market purchase offer for use in identification thereof, such as an identification number, referred to herein as an offer identifier. The receiving device 202 may also be configured to receive data signals electronically transmitted by payment networks 112, which may be superimposed or otherwise encoded with transaction messages, which may be transmitted via payment rails associated with the payment network 112, and may include notifications or responses regarding authorization holds, clearing of holds, and processing of payment transactions.

The processing server 102 may also include a communication module 204. The communication module 204 may be configured to transmit data between modules, engines, databases, memories, and other components of the processing server 102 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the processing server 102 and external components of the processing server 102, such as externally connected databases, display devices, input devices, etc. The processing server 102 may also include a processing device. The processing device may be configured to perform the functions of the processing server 102 discussed herein as will be apparent to persons having skill in the relevant art. In some embodiments, the processing device may include and/or be comprised of a plurality of engines and/or modules specially configured to perform one or more functions of the processing device, such as a querying module 214, transaction processing module 216, generation module 218, etc. As used herein, the term “module” may be software or hardware particularly programmed to receive an input, perform one or more processes using the input, and provides an output. The input, output, and processes performed by various modules will be apparent to one skilled in the art based upon the present disclosure.

In some embodiments, the processing server 102 may include an offer database 206. The offer database 206 may be configured to store a plurality of offer profiles 208 using a suitable data storage format and schema. The offer database 206 may be a relational database that utilizes structured query language for the storage, identification, modifying, updating, accessing, etc. of structured data sets stored therein. Each offer profile 208 may be a structured data set configured to store data related to a mass market purchase offer. An offer profile 208 may include, for instance, an offer identifier associated with the related offer, the minimum number of consumers 104, the transaction amount, product information, and any additional criteria provided by the merchant system 106, such as predetermined periods of time, additional numbers of consumers 104, additional transaction amounts, etc. In some cases, an offer profile 208 may also include the number of consumers 104 that have already accepted the offer, and data associated with the authorization holds placed as a result of the acceptances, such as transaction identifiers, payment credentials, or any other data that may be used to initiate the corresponding payment transactions or clear the authorization holds, as applicable.

The processing server 102 may include a querying module 214. The querying module 214 may be configured to execute queries on databases to identify information. The querying module 214 may receive one or more data values or query strings, and may execute a query string based thereon on an indicated database, such as the offer database 206, to identify information stored therein. The querying module 214 may then output the identified information to an appropriate engine or module of the processing server 102 as necessary. The querying module 214 may, for example, execute a query on the offer database 206 to identify an offer profile 208 included therein that includes a specific offer identifier included in an offer acceptance received by the receiving device 202, such as for identification of merchant account credentials and a transaction amount for use in submitting a transaction message to the payment network 112 for placement of an authorization hold.

The processing server 102 may also include a transaction processing module 216. The transaction processing module 216 may be configured to perform functions of the processing server 102 related to the initiation and processing of electronic payment transactions, as will be apparent to persons having skill in the relevant art. The transaction processing module 216 may be configured to, for example, generate transaction messages that are compliant with standards governing the exchange of transaction messages, such as the ISO 8583 or ISO 20022 standards, which may be submitted to payment networks 112 via payment rails associated therewith that are configured to place authorization holds on transaction accounts, clear already placed authorization holds, and process payment transactions corresponding to already placed authorization holds.

The processing server 102 may also include a generation module 218. The generation module 218 may be configured to generate data for use by the processing server 102 in performing the functions discussed herein. The generation module 218 may receive instructions as input, may generate data based on the instructions, and may output the generated data to another module or engine of the processing server 102. In some cases, data may be included in the instructions for use by the generation module 218 in generating the requested data, and or may be identified by the generation module 218 (e.g., by instructing the querying module 214) as required to satisfy the instructions. The generation module 218 may be configured to, for example, generation offer notifications, transaction messages, notifications of cleared authorization holds or processed payment transactions, etc.

The processing server 102 may also include a transmitting device 222. The transmitting device 222 may be configured to transmit data over one or more networks via one or more network protocols. In some instances, the transmitting device 222 may be configured to transmit data to merchant systems 106, computing devices 108, payment networks 112, and other entities via one or more communication methods, local area networks, wireless area networks, cellular communication, Bluetooth, radio frequency, the Internet, etc. In some embodiments, the transmitting device 222 may be comprised of multiple devices, such as different transmitting devices for transmitting data over different networks, such as a first transmitting device for transmitting data over a local area network and a second transmitting device for transmitting data via the Internet. The transmitting device 222 may electronically transmit data signals that have data superimposed that may be parsed by a receiving computing device. In some instances, the transmitting device 222 may include one or more modules for superimposing, encoding, or otherwise formatting data into data signals suitable for transmission.

The transmitting device 222 may be configured to electronically transmit data signals to merchant systems 106 that are superimposed or otherwise encoded with notifications regarding consumer 104 acceptance of a mass market purchase offer. For instance, the processing server 102 may inform the merchant system 106 when an acceptance occurs, may provide regular updates on the number of acceptances, may inform the merchant system 106 when a minimum number of acceptances has been reached, and may provide the merchant system 106 with notifications regarding processed payment transactions and/or cleared authorization holds. The transmitting device 222 may also be configured to electronically transmit data signals to computing devices 108, which may be superimposed or otherwise encoded with offer notifications, which may include at least a minimum acceptance number, product information, and a transaction amount, or with notifications regarding authorization holds, cleared authorization holds, processed payment transactions, or other messages as discussed herein. The transmitting device 222 may also be configured to electronically transmit data signals to payment networks 112 via payment rails associated therewith that are superimposed or otherwise encoded with transaction messages, such as for the placing or clearing of authorization holds and the processing of payment transactions corresponding to authorization holds.

The processing server 102 may also include a memory 224. The memory 224 may be configured to store data for use by the processing server 102 in performing the functions discussed herein, such as public and private keys, symmetric keys, etc. The memory 224 may be configured to store data using suitable data formatting methods and schema and may be any suitable type of memory, such as read-only memory, random access memory, etc. The memory 224 may include, for example, encryption keys and algorithms, communication protocols and standards, data formatting standards and protocols, program code for modules and application programs of the processing device, and other data that may be suitable for use by the processing server 102 in the performance of the functions disclosed herein as will be apparent to persons having skill in the relevant art. In some embodiments, the memory 224 may be comprised of or may otherwise include a relational database that utilizes structured query language for the storage, identification, modifying, updating, accessing, etc. of structured data sets stored therein. The memory 224 may be configured to store, for example, transaction formatting rules, mass market purchase bid selection criteria, etc.

### Process for Distributing a Mass Market Purchase Offer

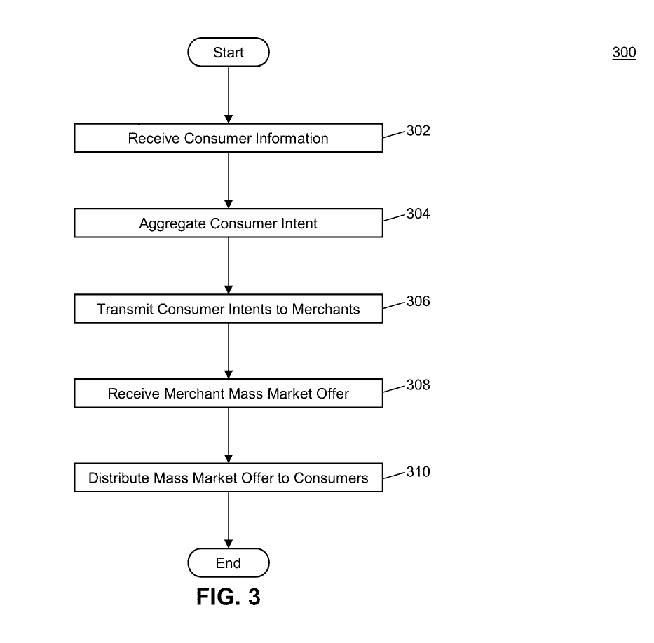

FIG. 3 illustrates a process executed by the processing server 102 for the creation and distribution of an offer for a mass market purchase in the system 100 of FIG. 1.

In step 302, the receiving device 202 of the processing server 102 may receive consumer information from a plurality of different consumers 104 (e.g., via computing devices 108 associated therewith) that may include data regard consumer desires with respect to product purchases. The information may include, for instance, indications of one or more products that the consumer 104 may wish to purchase, and prices or price ranges that would encourage consumer 104 participation in a mass market purchase. In step 304, the processing server 102 may aggregate the information received from consumers 104, to identify potential mass market purchasing opportunities, such as by aggregating the consumer prices or price ranges for a specific product or set of products.

In step 306, the transmitting device 222 of the processing server 102 may electronically transmit the aggregated consumer information to one or more merchant systems 106. The merchant systems 106 may receive the data and may design mass market purchase offers that would satisfy consumer desires and be suitable for the merchant. In step 308, the receiving device 202 of the processing server 102 may receive a mass market purchase offer from one or more merchant systems 106. Each offer may include product information associated with one or more products to be purchased in the offer, a minimum acceptance number of consumers 114 required to accept the offer for it to be honored, and a transaction amount that represents a discounted price for the product(s) that the consumers 104 would pay if the sufficient number of consumers 104 commits. In instances where multiple offers may be received from one or more merchant systems 106, the processing server 102 may be configured to select one offer to distribute to consumers 104 based on the criteria set forth therein, such as discussed above. For example, merchant systems 106 may bid or a mass market purchase offer that is most advantageous for consumers 104 may be identified.

Once a single mass market purchase offer has been received or identified, then, in step 310, the transmitting device 222 of the processing server 102 may electronically transmit an offer notification to a plurality of different consumers 104. The offer notification may include at least the product information, minimum acceptance number, and transaction amount. The offer notification may also include any additional criteria applicable to the mass market purchase offer, such as one or more predetermined period of time, additional acceptance numbers, additional transaction amounts, etc. In cases where an offer may be assigned an offer identifier, the offer notification may also include the offer identifier associated therewith for use in identification of subsequent communications.

### Processing of Mass Market Purchases

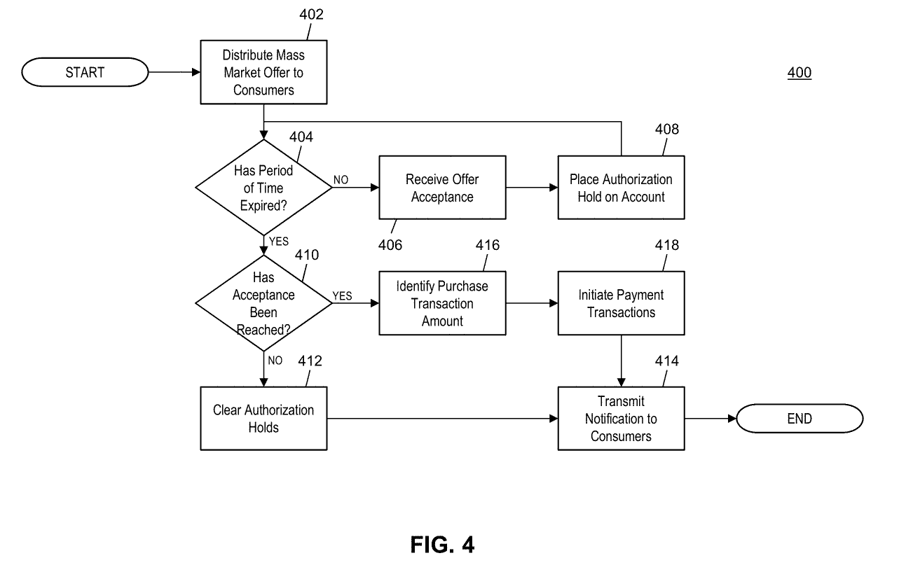

FIG. 4 illustrates a process 400 for the processing of mass market purchases via the use of authorization holds for the facilitation of mass market purchases between consumers 104 and merchant systems 106 in the system 100 of FIG. 1 as executed by the processing server 102.

In step 402, the transmitting device 222 of the processing server 102 may distribute offer notifications for a mass market purchase offer to a plurality of computing devices 108 using suitable communication networks and methods, such as via an application program executed by the computing devices 108. The offer notification may include at least the product information, minimum acceptance number, and transaction amount and may also include an offer notification, as applicable, and any additional criteria applicable to the mass market purchase offer, such as one or more predetermined period of time, additional acceptance numbers, additional transaction amounts, etc. Each computing device 108 may receive the offer notification and may display the corresponding data to the consumer 104 and prompt the consumer 104 for acceptance of the offer and input and/or selection of payment credentials if acceptance is desired.

In step 404, the processing server 102 may determine if a predetermined period of time set forth for acceptance of the mass market purchase offer by the corresponding merchant system 106 has expired. If the time has not yet expired, then, in step 406, the receiving device 202 of the processing server 102 may receive offer acceptances from computing devices 108 for the mass market purchase offer. Each offer acceptance may include at least an offer identifier associated with the offer being accepted, if applicable, and payment credentials associated with a transaction account to be used to fund the purchase by the respective consumer 104. In step 408, the generation module 218 of the processing server 102 may generate a transaction message for each offer acceptance that is configured to place an authorization hold on the transaction account corresponding to the received payment credentials for the transaction amount set forth in the mass market purchase offer (e.g., identified in an offer profile 208 of the offer database 206 of the processing server 102 using the offer identifier), which may be submitted to the payment network 112 via payment rails associated therewith by the transmitting device 222 of the processing server 102 and processed accordingly thereby. The process 400 may then return to step 404 to determine if the period of time has expired.

Once the period of time expires, as determined in step 404, then the processing server 102 may determine if the minimum acceptance number set forth in the mass market purchase offer (e.g., identified in an offer profile 208 of the offer database 206 of the processing server 102 using the offer identifier) has been met based on the number of received offer acceptances and successfully placed authorization holds. If the minimum acceptance number has not been met, then, in step 412, the generation module 218 of the processing server 102 may generate transaction messages that are configured to clear the previously placed authorization holds, which may be submitted to the payment network 112 via payment rails associated therewith by the transmitting device 222 of the processing server 102. In step 414, the transmitting device 222 may electronically transmit notifications to the computing devices 108 associated with the consumers 104 that had previously accepted the mass market purchase offer that notify the consumer 104 that the minimum acceptance number had not been reached and their authorization hold cleared. In some cases, the notification may include the number of acceptances that had been received. The mass market purchase offer may then be closed. In some cases, the merchant system 106 may be contacted to set up a new, alternative mass market purchase offer.

If, in step 410, the processing server 102 determines that the minimum acceptance number had been met, then, in step 416, the processing server 102 may identify the transaction amount to be used for the mass market purchase offer. The querying module 214 of the processing server 102 may execute a query on the offer database 206 of the processing server 102 to identify an offer profile 208 associated with the mass market purchase offer (e.g., using the offer identifier) and identify a transaction amount included therein. In cases where an offer may have multiple transaction amounts associated therewith, such as based on multiple acceptance numbers, the querying module 214 may identify the transaction amount that is to be applicable to the mass market purchase based on the number of acceptances or other criteria as set in the offer profile 208.

Once the transaction amount has been identified, then, in step 418, the generation module 218 of the processing server 102 may generate transaction messages that are configured to process payment transactions corresponding to the previously placed authorization holds, which may be submitted to the payment network 112 via payment rails associated therewith by the transmitting device 222 of the processing server 102 and processed by the payment network 112 accordingly for payment of the identified transaction amount from the respective transaction account to a transaction account associated with the merchant system 106. The process 400 may then proceed to step 414, where the transmitting device 222 may electronically transmit notifications to the computing devices 108 associated with the consumers 104 that had accepted the mass market purchase offer to notify the consumer 104 that the mass market purchase offer had been met and processed, which may also include the transaction amount at which the offer was processed. In some cases, a notification may also be electronically transmitted to the merchant system 106 regarding completion of the mass market purchase offer, which may include the total number of acceptances.

### Exemplary Method for Facilitating a Mass Market Purchase

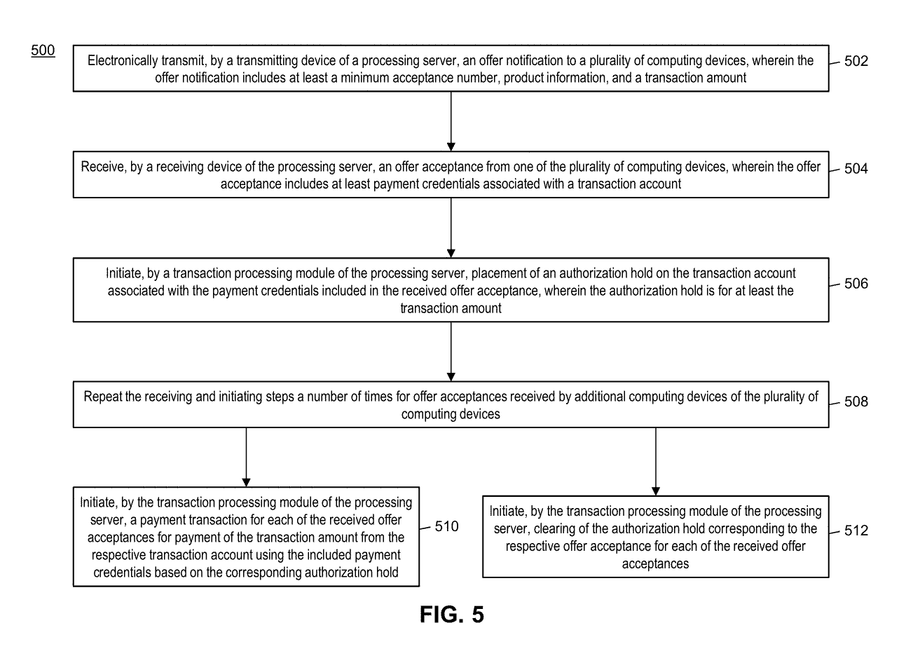

FIG. 5 illustrates a method 500 for the facilitation of a mass market purchase via the use of authorization holds that ensure commitment to consumer participation in a mass market purchase offered by a merchant.

In step 502, an offer notification may be electronically transmitted by a transmitting device (e.g., the transmitting device 222) of a processing server (e.g., the processing server 102) to a plurality of computing devices (e.g., computing devices 108), wherein the offer notification includes at least a minimum acceptance number, product information, and a transaction amount. In step 504, an offer acceptance may be received by a receiving device (e.g., the receiving device 202) of the processing server from one of the plurality of computing devices, wherein the offer acceptance includes at least payment credentials associated with a transaction account.

In step 506, placement of an authorization hold on the transaction account associated with the payment credentials included in the received offer acceptance may be initiated by a transaction processing module (e.g., the transaction processing module 216) of the processing server, wherein the authorization hold is for at least the transaction amount. In step 508, the receiving and initiating steps may be repeated a number of times for offer acceptances received by additional computing devices of the plurality of computing devices.

If the number of times the receiving and initiating steps are repeated is at least the minimum acceptance number, then, in step 510, a payment transaction may be initiated by the transaction processing module of the processing server for each of the received offer acceptances for payment of the transaction amount from the respective transaction account using the included payment credentials based on the corresponding authorization hold. If the number of times the receiving and initiating steps are repeated is less than the minimum acceptance number, then, in step 512, the transaction processing module of the processing server may initiate clearing of the authorization hold corresponding to the respective offer acceptance for each of the received offer acceptances.

In one embodiment, the offer notification may further include an expiration date. In a further embodiment, the receiving and initiating steps may be repeated by the processing server until the expiration date. In some embodiments, the offer notification may further include a secondary acceptance number and a secondary transaction amount less than the transaction amount, and if the number of times is at least the secondary acceptance number, the payment transaction for each of the received offer acceptances may be initiated for the secondary transaction amount in place of the transaction amount.

In one embodiment, the method 500 may further include receiving, by the receiving device of the processing server, at least the minimum acceptance number, transaction amount, and merchant account credentials from a merchant computing system (e.g., the merchant system 106), wherein each payment transaction is for payment of the transaction amount to a transaction account associated with the merchant account credentials. In a further embodiment, the minimum acceptance number and transaction amount may be received from the merchant computing system prior to electronic transmission of offer notifications. In some embodiments, the offer notification may be electronically transmitted to each of the computing devices as a push notification to an application program executed by the respective computing device. In one embodiment, the offer notification may be electronically transmitted to each of the computing devices in web page data for display in a web page on the respective computing device.

### Computer System Architecture

FIG. 6 illustrates a computer system 600 in which embodiments of the present disclosure, or portions thereof, may be implemented as computer-readable code. For example, the processing server 102 of FIG. 1 may be implemented in the computer system 600 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3-5.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 618, a removable storage unit 622, and a hard disk installed in hard disk drive 612.

Various embodiments of the present disclosure are described in terms of this example computer system 600. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 604 may be a special purpose or a general purpose processor device specifically configured to perform the functions discussed herein. The processor device 604 may be connected to a communications infrastructure 606, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 600 may also include a main memory 608 (e.g., random access memory, read-only memory, etc.), and may also include a secondary memory 610. The secondary memory 610 may include the hard disk drive 612 and a removable storage drive 614, such as a floppy disk drive, a magnetic tape drive, an optical disk drive, a flash memory, etc.

The removable storage drive 614 may read from and/or write to the removable storage unit 618 in a well-known manner. The removable storage unit 618 may include a removable storage media that may be read by and written to by the removable storage drive 614. For example, if the removable storage drive 614 is a floppy disk drive or universal serial bus port, the removable storage unit 618 may be a floppy disk or portable flash drive, respectively. In one embodiment, the removable storage unit 618 may be non-transitory computer readable recording media.

In some embodiments, the secondary memory 610 may include alternative means for allowing computer programs or other instructions to be loaded into the computer system 600, for example, the removable storage unit 622 and an interface 620. Examples of such means may include a program cartridge and cartridge interface (e.g., as found in video game systems), a removable memory chip (e.g., EEPROM, PROM, etc.) and associated socket, and other removable storage units 622 and interfaces 620 as will be apparent to persons having skill in the relevant art.

Data stored in the computer system 600 (e.g., in the main memory 608 and/or the secondary memory 610) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 600 may also include a communications interface 624. The communications interface 624 may be configured to allow software and data to be transferred between the computer system 600 and external devices. Exemplary communications interfaces 624 may include a modem, a network interface (e.g., an Ethernet card), a communications port, a PCMCIA slot and card, etc. Software and data transferred via the communications interface 624 may be in the form of signals, which may be electronic, electromagnetic, optical, or other signals as will be apparent to persons having skill in the relevant art. The signals may travel via a communications path 626, which may be configured to carry the signals and may be implemented using wire, cable, fiber optics, a phone line, a cellular phone link, a radio frequency link, etc.

The computer system 600 may further include a display interface 602. The display interface 602 may be configured to allow data to be transferred between the computer system 600 and external display 630. Exemplary display interfaces 602 may include high-definition multimedia interface (HDMI), digital visual interface (DVI), video graphics array (VGA), etc. The display 630 may be any suitable type of display for displaying data transmitted via the display interface 602 of the computer system 600, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 608 and secondary memory 610, which may be memory semiconductors (e.g., DRAMs, etc.). These computer program products may be means for providing software to the computer system 600. Computer programs (e.g., computer control logic) may be stored in the main memory 608 and/or the secondary memory 610. Computer programs may also be received via the communications interface 624. Such computer programs, when executed, may enable computer system 600 to implement the present methods as discussed herein. In particular, the computer programs, when executed, may enable processor device 604 to implement the methods illustrated by FIGS. 3-5, as discussed herein. Accordingly, such computer programs may represent controllers of the computer system 600. Where the present disclosure is implemented using software, the software may be stored in a computer program product and loaded into the computer system 600 using the removable storage drive 614, interface 620, and hard disk drive 612, or communications interface 624.

The processor device 604 may comprise one or more modules or engines configured to perform the functions of the computer system 600. Each of the modules or engines may be implemented using hardware and, in some instances, may also utilize software, such as corresponding to program code and/or programs stored in the main memory 608 or secondary memory 610. In such instances, program code may be compiled by the processor device 604 (e.g., by a compiling module or engine) prior to execution by the hardware of the computer system 600. For example, the program code may be source code written in a programming language that is translated into a lower level language, such as assembly language or machine code, for execution by the processor device 604 and/or any additional hardware components of the computer system 600. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 600 to perform the functions disclosed herein. It will be apparent to persons having skill in the relevant art that such processes result in the computer system 600 being a specially configured computer system 600 uniquely programmed to perform the functions discussed above.

Techniques consistent with the present disclosure provide, among other features, systems and methods for facilitating a mass market purchase. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for facilitating a mass market purchase, comprising:
electronically transmitting, by a transmitting device of a processing server, an offer notification to a plurality of computing devices, wherein the offer notification includes at least a minimum acceptance number, product information, and a transaction amount;
receiving, by a receiving device of the processing server, an offer acceptance from one of the plurality of computing devices, wherein the offer acceptance includes at least payment credentials associated with a transaction account;
initiating, by a transaction processing module of the processing server, placement of an authorization hold on the transaction account associated with the payment credentials included in the received offer acceptance, wherein the authorization hold is for at least the transaction amount;
repeating the receiving and initiating steps a number of times for offer acceptances received by additional computing devices of the plurality of computing devices; and
if the number of times is at least the minimum acceptance number, initiating, by the transaction processing module of the processing server, a payment transaction for each of the received offer acceptances for payment of the transaction amount from the respective transaction account using the included payment credentials based on the corresponding authorization hold, or
if the number of times is less than the minimum acceptance number, initiating, by the transaction processing module of the processing server, clearing of the authorization hold corresponding to the respective offer acceptance for each of the received offer acceptances.

2. The method of claim 1, wherein the offer notification further includes an expiration date.

3. The method of claim 2, wherein the receiving and initiating steps are repeated by the processing server until the expiration date.

4. The method of claim 1, wherein
the offer notification further includes a secondary acceptance number and a secondary transaction amount less than the transaction amount, and
if the number of times is at least the secondary acceptance number, initiating the payment transaction for each of the received offer acceptances for the secondary transaction amount in place of the transaction amount.

5. The method of claim 1, further comprising:
receiving, by the receiving device of the processing server, at least the minimum acceptance number, transaction amount, and merchant account credentials from a merchant computing system, wherein
each payment transaction is for payment of the transaction amount to a transaction account associated with the merchant account credentials.

6. The method of claim 5, wherein the minimum acceptance number and transaction amount are received from the merchant computing system prior to electronic transmission of offer notifications.

7. The method of claim 1, wherein the offer notification is electronically transmitted to each of the computing devices as a push notification to an application program executed by the respective computing device.

8. The method of claim 1, wherein the offer notification is electronically transmitted to each of the computing devices in web page data for display in a web page on the respective computing device.

9. A system for facilitating a mass market purchase, comprising:
a transmitting device of a processing server configured to electronically transmit an offer notification to a plurality of computing devices, wherein the offer notification includes at least a minimum acceptance number, product information, and a transaction amount;
a receiving device of the processing server configured to receive an offer acceptance from one of the plurality of computing devices, wherein the offer acceptance includes at least payment credentials associated with a transaction account;
a transaction processing module of the processing server configured to initiate placement of an authorization hold on the transaction account associated with the payment credentials included in the received offer acceptance, wherein the authorization hold is for at least the transaction amount, wherein
receiving an offer acceptance and initiating placement of an authorization hold are repeated a number of times for offer acceptances received by additional computing devices of the plurality of computing device, and
if the number of times is at least the minimum acceptance number the transaction processing module of the processing server is further configured to initiate a payment transaction for each of the received offer acceptances for payment of the transaction amount from the respective transaction account using the included payment credentials based on the corresponding authorization hold, or
if the number of times is less than the minimum acceptance number the transaction processing module of the processing server is further configured to initiate clearing of the authorization hold corresponding to the respective offer acceptance for each of the received offer acceptances.

10. The system of claim 9, wherein the offer notification further includes an expiration date.

11. The system of claim 10, wherein the receiving and initiating steps are repeated by the processing server until the expiration date.

12. The system of claim 9, wherein
the offer notification further includes a secondary acceptance number and a secondary transaction amount less than the transaction amount, and
if the number of times is at least the secondary acceptance number, initiating the payment transaction for each of the received offer acceptances for the secondary transaction amount in place of the transaction amount.

13. The system of claim 9, wherein
the receiving device of the processing server is further configured to receive at least the minimum acceptance number, transaction amount, and merchant account credentials from a merchant computing system, and
each payment transaction is for payment of the transaction amount to a transaction account associated with the merchant account credentials.

14. The system of claim 13, wherein the minimum acceptance number and transaction amount are received from the merchant computing system prior to electronic transmission of offer notifications.

15. The system of claim 9, wherein the offer notification is electronically transmitted to each of the computing devices as a push notification to an application program executed by the respective computing device.

16. The system of claim 9, wherein the offer notification is electronically transmitted to each of the computing devices in web page data for display in a web page on the respective computing device.
